(19) United States
(12) Patent Application Publication
(10) Pub. No.: US 2022/0101873 A1
(43) Pub. Date: Mar. 31, 2022

(54) TECHNIQUES FOR PROVIDING FEEDBACK ON THE VERACITY OF SPOKEN STATEMENTS

(71) Applicant: HARMAN INTERNATIONAL INDUSTRIES, INCORPORATED, Stamford, CT (US)

(72) Inventors: Evgeny BURMISTROV, Saratoga, CA (US); Joseph VERBEKE, San Francisco, CA (US); Priya SESHADRI, San Francisco, CA (US); Stefan MARTI, Oakland, CA (US)

(21) Appl. No.: 17/039,945

(22) Filed: Sep. 30, 2020

(51) Int. Cl. G10L 25/51; G10L 25/78; G06F 3/01; G06F 3/16

(52) U.S. Cl. CPC G10L 25/51; G10L 25/78; G06F 3/017; G06F 3/16; G06F 3/015; G06F 3/016

(57) ABSTRACT

Embodiments of the present disclosure set forth a computer-implemented method comprising detecting a speech portion included in a first auditory signal generated by a speaker, determining that the speech portion comprises a factual statement, comparing the factual statement with a first fact included in a first data source, determining, based on comparing the factual statement with the first fact, a fact truthfulness value, and providing a response signal that indicates the fact truthfulness value.

### BACKGROUND

### Field of the Various Embodiments

Embodiments disclosed herein relate to digital assistants and, in particular, techniques for providing feedback on the veracity of spoken statements.

### Description of the Related Art

The establishment of the Internet has made information on essentially any subject readily available to anyone with an Internet connection. Furthermore, the widespread use of smart phones, wearables, and other wireless devices provides many users an Internet connection most of the time. Freed from the necessity of a wired connection, users can now perform an Internet search by opening a web browser on a smartphone or electronic tablet whenever wireless service is available. In addition, the incorporation of intelligent personal assistants (IPAs) into wireless devices, such as Microsoft Cortana™, Apple Siri™, and Amazon Alexa™, enables users to initiate a search for information on a particular topic without looking at a display screen or manually entering search parameters. Instead, the user can retrieve information from the Internet verbally by speaking a question to the IPA.

In general, in order to perform an Internet search regarding certain information, a person performing the search must actively input queries that provide specific information about the subject of interest. In many cases, however, a person may not readily be able to perform such searches. For example, a person may conduct a conversation with other people where, during the conversation, a person may make a factual statement. The user may not be able to freely halt the conversation in order to assess whether the factual statement is true. Consequently, the user must wait until after the conversation ends to consult with sources in order to check the accuracy of the factual statement. Waiting to check the accuracy of a factual statement may cause a person to forget certain statements, as well as forget the overall accuracy of information provided by a given person.

In light of the above, more effective techniques for evaluating the veracity of spoken statements would be useful.

### SUMMARY

Embodiments of the present disclosure set forth a computer-implemented method comprising detecting a speech portion included in a first auditory signal generated by a speaker, determining that the speech portion comprises a factual statement, comparing the factual statement with a first fact included in a first data source, determining, based on comparing the factual statement with the first fact, a fact truthfulness value, and providing a response signal that indicates the fact truthfulness value.

Further embodiments provide, among other things, non-transitory computer-readable storage media storing instructions for implementing the method set forth above, as well as a system configured to implement the method set forth above.

At least one technological advantage of the disclosed approach relative to the prior art is that by processing and assessing factual statements made by a speaker, as well as cues made by the speaker in real-time, the disclosed approach provides the user with relevant feedback about factual statements and the intent of the speaker without requiring the user to take affirmative steps, interrupt conversations, and/or follow-up on statements at a later time. Further, providing assessments regarding the factual veracity of statements made by a speaker enables a user to better assess facts presented to the user based on both a statement made by a speaker, as well as other cues associated with the speaker. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a veracity assessment system according to one or more embodiments;

FIG. 2 illustrates components of a fact processing application included in the veracity assessment system of FIG. 1, according to one or more embodiments;

FIG. 3, illustrates a technique for processing a candidate factual statement made by a speaker by the veracity assessment system of FIG. 1 processing a candidate factual statement made by a speaker, according to one or more embodiments; and

FIG. 4 is a flow diagram of method steps to process a candidate factual statement made by a speaker, according to one or more embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### Overview

Embodiments disclosed herein include a veracity assessment system that includes a fact processing application that continually analyzes portions of speech made by a speaker and provides feedback about whether the statement is truthful and whether the speaker is attempting to be truthful. A processing unit included in the veracity assessment system operates to receive an input speech signal from a speaker that is talking to a user. The processing unit parses the input speech signal to determine whether the speech portion is a candidate factual statement. The processing unit searches data stores to identify known facts associated with the candidate factual statement and compares the candidate factual statement with the known facts. Based on the comparison, the processing unit generates a fact truthfulness value that indicates a likelihood that the candidate factual statement is true.

The processing unit also processes the input speech signal and other physiological data in order to generate a veracity value that indicates a likelihood that the speaker is attempting to tell the truth. The processing unit includes the fact truthfulness value and veracity value in a set of fact veracity assessments. The processing unit generates one or more feedback signals based on the set of fact veracity assessments, where the feedback signal drives an output device to provide values included in the set of fact veracity assessments. For example, the processing unit could generate an auditory feedback signal that separately indicates the fact truthfulness value and veracity value; the processing unit could then drive a loudspeaker to emit soundwaves corresponding to the auditory feedback signal.

The veracity assessment system may be implemented in various forms of audiovisual-based systems, such as personal headphones, earpieces, mobile devices, personal computers, AR/VR gear and head-mounted displays, wearables (wrist watch, wristband, ring, thimble, etc.), Hearables (in-ear canal devices, smart earbuds), around-neck audio devices, smart hats and smart helmets, integrated in clothing (shirt, scarf, belt, etc.), integrated into jewelry (ear ring, bracelet, necklace, arm bracelet).

The veracity assessment system may perform its processing functions using a dedicated processing device and/or a separate computing device, such as a mobile computing device of a user or a cloud computing system. The veracity assessment system may detect speech from a speaker using any number of auditory sensors, which may be attached to or integrated with other system components, or disposed separately. The veracity assessment system may also acquire physiological data associated with the speaker using any type of sensor. The veracity assessment system uses the sensor data and auditory data to identify factual statements and provide a user with feedback regarding the likelihood that the statement is factually true and/or whether the speaker is telling the truth.

### System

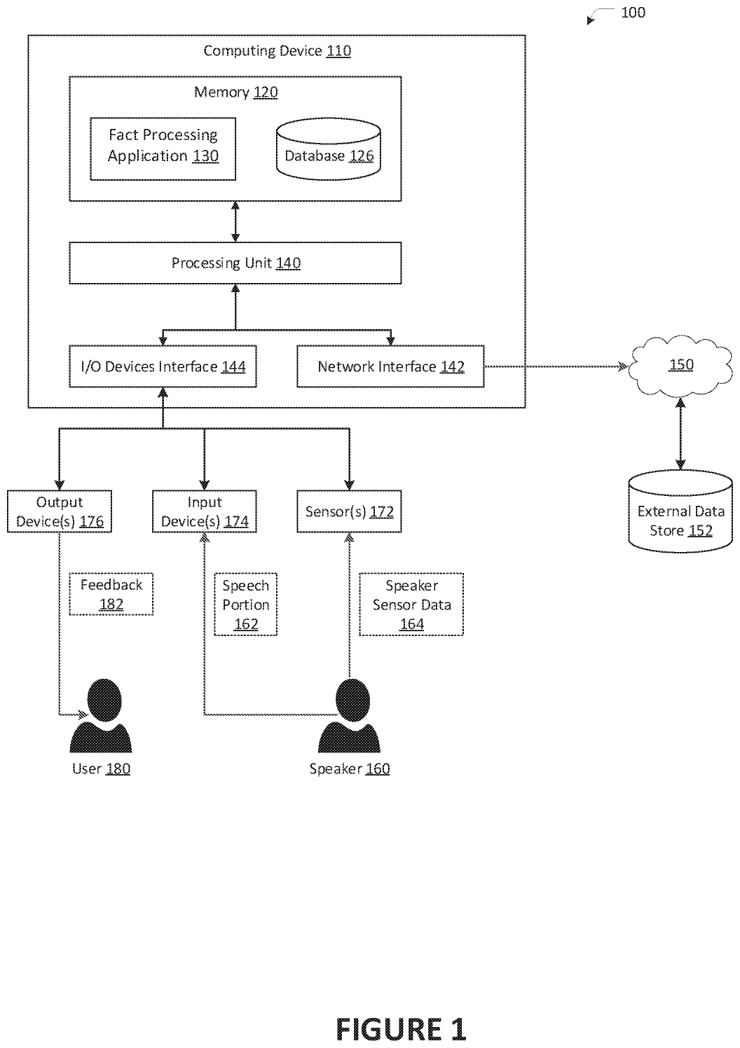

FIG. 1 illustrates a veracity assessment system according to one or more embodiments. As shown, veracity assessment system 100 includes computing device 110, network 150, external data store 152, sensor(s) 172, input device(s) 174, and output device(s) 176. Computing device 110 includes memory 120, processing unit 140, network interface 142, and input/output devices interface 144. Memory 120 includes database 126 and fact processing application 130.

Computing device 110 includes processing unit 140 and memory 120. In various embodiments, computing device 110 may be a device that includes one or more processing units 140, such as a system-on-a-chip (SoC). In some embodiments, computing device 110 may be a wearable device, such as hearing aids, headphones, ear buds, portable speakers, smart eyeglasses, wrist watches, smart rings, smart necklaces, and/or other devices that include processing unit 140. In other embodiments, computing device 110 may be a computing device, such as a tablet computer, desktop computer, mobile phone, media player, and so forth. In some embodiments, computing device 110 may be a head unit included in a vehicle system or at-home entertainment system. Generally, computing device 110 can be configured to coordinate the overall operation of veracity assessment system 100. The embodiments disclosed herein contemplate any technically-feasible system 100 configured to implement the functionality of veracity assessment system 100 via computing device 110.

In various embodiments, one or more of computing device 110, sensor(s) 172, input device(s) 174, and/or output device(s) 176 may be included in one or more devices, such as AR/VR gear and head-mounted displays, mobile devices (e.g., cellphones, tablets, laptops, etc.), wearable devices (e.g., watches, wristband, ring, thimble, rings, bracelets, headphones, etc.), devices integrated in clothing (shirt, scarf, belt, etc.), devices integrated into jewelry (ear ring, bracelet, necklace, arm bracelet), consumer products (e.g., gaming, gambling, etc. products), hearables (in-ear canal devices, smart earbuds), around-neck audio devices, smart hats and smart helmets, smart home devices (e.g., smart lighting systems, security systems, digital assistants, etc.), communications systems (e.g., conference call systems, video conferencing systems, etc.), and so forth. Computing device 110 may be located in various environments including, without limitation, building environments (e.g., living room, conference room, home office, etc.), road vehicle environments (e.g., consumer car, commercial truck, etc.), aerospace and/or aeronautical environments (e.g., airplanes, helicopters, spaceships, etc.), nautical and submarine environments, outdoor environments, and so forth.

For example, a wearable device could include at least one microphone as input device 174, at least one speaker as output device 176, and a microprocessor-based digital signal processor (DSP) as processing unit 140 that produces auditory signals that drive the at least one speaker to emit soundwaves. In some embodiments, veracity assessment system 100 may be included in a digital voice assistant that includes one or more microphones, one or more loudspeakers, and one or more processing units. In some embodiments, various components of veracity assessment system 100 may be contained within, or implemented by, different kinds of wearable devices and/or non-wearable devices. For example, one or more of computing device 110, sensor(s) 172, input device(s) 174, and/or output device(s) 176 could be disposed within a hat, scarf, shirt collar, jacket, hood, etc. Similarly, processing unit 140 could provide user interface 122 via output device(s) 176 that are included in a separate mobile or wearable device, such as a smartphone, tablet, wristwatch, arm band, etc. The separate mobile or wearable device could include an associated microprocessor and/or a digital signal processor that could also be used to provide additional processing power to augment the capabilities of the computing device 110.

Processing unit 140 may include a central processing unit (CPU), a digital signal processing unit (DSP), a microprocessor, an application-specific integrated circuit (ASIC), a neural processing unit (NPU), a graphics processing unit (GPU), a field-programmable gate array (FPGA), and so forth. Processing unit 140 generally comprises a programmable processor that executes program instructions to manipulate input data. In some embodiments, processing unit 140 may include any number of processing cores, memories, and other modules for facilitating program execution. For example, processing unit 140 could receive an input (e.g., speech portion 162 and/or speaker sensor data 164) from speaker 160 via input device(s) 174 and/or sensor(s) 172 and drive output device(s) 176 to provide feedback 182 to user 180, where feedback 182 includes a fact truthfulness value and/or a veracity value. Additionally or alternatively, processing unit 140 may provide feedback 182 based statements spoken by user 180.

In some embodiments, processing unit 140 can be configured to execute fact processing application 130 in order to identify factual statements made by speaker 160 and provide feedback 182 to user 180, where the specific feedback 182 provided to user 180 includes a fact truthfulness value indicating a likelihood that the factual statement is true. In various embodiments, processing unit 140 may execute fact processing application 130 in order to retrieve known facts from external data store(s) 152 in order to determine whether a candidate factual statement is objectively true.

Additionally or alternatively, fact processing application 130 may determine whether speech portion 162 and/or physiological data associated with the speaker 160 indicate whether speaker 160 is acting in a manner usually classified as truthful, deceitful, unknowing, and so forth. In various embodiments, fact processing application 130 may analyze speech portion 162, as well as verbal (e.g., tone, stress, etc.) and non-verbal cues provided by speaker 160 when assessing whether speaker 160 is attempting to tell the truth. In such instances, fact processing application 130 may cause output device 176 to provide feedback 182 that includes a veracity value indicating a likelihood that the speaker 160 is attempting to make a factual statement that is true, whether speaker 160 is lying, and/or the like.

In some embodiments, the fact processing application 130 may independently generate the fact truthfulness value and the veracity value. For example, fact processing application 130 could generate a high veracity value and a low fact truthfulness value, indicating that speaker 160 is mistakenly reciting untrue information as fact. Conversely, fact processing application 130 could generate a low veracity value and a high fact truthfulness value, indicating that speaker 160 is attempting to lie to you but is actually reciting a truthful statement. Alternatively, the fact truthfulness value and the veracity value coincide (e.g., low values indicate an attempt at a lie, while high values indicate an attempt to provide a true fact). In such instances, fact processing application 130 may generate the fact truthfulness value and the veracity value with greater confidence.

Memory 120 includes a memory module, or collection of memory modules. Memory 120 may include a variety of computer-readable media selected for their size, relative performance, or other capabilities: volatile and/or non-volatile media, removable and/or non-removable media, etc. Memory 120 may include cache, random access memory (RAM), storage, etc. Memory 120 may include one or more discrete memory modules, such as dynamic RAM (DRAM) dual inline memory modules (DIMMs). Of course, various memory chips, bandwidths, and form factors may alternately be selected.

Non-volatile memory included in memory 120 generally stores application programs including fact processing application 130, and data (e.g., data stored in database 126) for processing by processing unit 140. In various embodiments, memory 120 may include non-volatile memory, such as optical drives, magnetic drives, flash drives, or other storage. In some embodiments, separate data stores, such as external data store 152 included in network 150 (“cloud storage”) may supplement memory 120. Fact processing application 130 within memory 120 can be executed by processing unit 140 to implement the overall functionality of computing device 110 and, thus, to coordinate the operation of transparent sound management system 100 as a whole.

In various embodiments, memory 120 may include one or more modules for performing various functions or techniques described herein. In some embodiments, one or more of the modules and/or applications included in memory 120 may be implemented locally on computing device 110, and/or may be implemented via a cloud-based architecture. For example, any of the modules and/or applications included in memory 120 could be executed on a remote device (e.g., smartphone, a server system, a cloud computing platform, etc.) that communicates with computing device 110 via network interface 142 or I/O devices interface 144.

Fact processing application 130 includes one or more modules that parse speech portion 162 made by speaker 160 and provide feedback 182 that is based at least on speech portions 162. In such instances, fact processing application 130 causes computing device 110 to provide feedback 182 that indicates, for example whether speech portion 162 includes a factual statement that is true. In various embodiments, fact processing application 130 may implement one or more modules to process speech portion and/or speaker sensor data 164 in order to determine whether speaker 160 made a factual statement and, if so, the likelihood that the factual statement is true.

In various embodiments, fact processing application 130 continually processes statements made by speaker 160 and/or user 180 and determines the likelihood that each successive statement is true and/or the likelihood that speaker 160 is attempting to tell the truth. In some embodiments, fact processing application 130 may maintain a speaker veracity database in database 126 that identifies separate speakers and tracks how truthful a given speaker was when making previous factual statements. In such instances, fact processing application 130 may refer to the speaker veracity database when determining the likelihood that the speaker is attempting to provide a factual statement that is true.

In some embodiments, fact processing application 130 provides a user interface that enables a user to provide input(s) about specific external data stores 152 to use for fact checking and/or speakers 160. In some embodiments, the user interface may take any feasible form for providing the functions described herein, such as one or more buttons, toggles, sliders, dials, knobs, etc., or as a graphical user interface (GUI).

The user interface may be provided through any component of veracity assessment system 100. In one embodiment, the user interface may be provided by a separate computing device that is communicatively coupled with computing device 110, such as through an application running on a user's mobile or wearable computing device. In another example, user interface 122 may receive verbal commands for user selections. In this case, computing device 110 may perform speech recognition on the received verbal commands and/or compare the verbal commands against commands stored in memory 120. After verifying the received verbal commands, computing device 110 could then execute the commanded function for veracity assessment system 100 (e.g., identifying a specific speaker).

Database (DB) 126 may store values and other data retrieved by processing unit 140 to coordinate the operation of veracity assessment system 100. In various embodiments, in operation, processing unit 140 may be configured to store values in database 126 and/or retrieve values stored in database 126. For example, database 126 may store sensor data, audio content (e.g., audio clips, previous speech portions, etc.), speaker veracity database, and/or one or more data stores that act as a source of truth. For example, database 126 may store a calendar associated with the user. When speaker 160 makes a statement specific to the schedule of user 180, fact processing application 130 could refer to the calendar in lieu of an external data store 152.

In some embodiments, computing device 110 may communicate with other devices, such as sensor(s) 172, input device(s) 174, and/or output device(s) 176, using input/output (I/O) devices interface 144. In such instances, I/O devices interface 144 may include any number of different I/O adapters or interfaces used to provide the functions described herein. For example, I/O devices interface 144 could include wired and/or wireless connections, and may use various formats or protocols. In another example, computing device 110, through I/O devices interface 144, could receive auditory signals from input device(s) 174, may detect physiological data, visual data, and so forth using audio sensor(s) 172, and may provide feedback signals to output device(s) 176 to produce feedback 182 in various types (e.g., visual indication, soundwaves, haptic sensations, proprioceptive sensations, temperature sensations, etc.). For example, output device 176 could provide a proprioceptive sensation via a shape-changing interface, such as when output device 176 is a ring that contracts. In another example, output device 176 could provide temperature sensations by providing thermal feedback, such as when output device 176 gets warmer or colder based on a veracity of the speaker.

In some embodiments, computing device 110 may communicate with other devices, such as external data store 152, using network interface 142 and network 150. In some embodiments, other types of networked computing devices (not shown) may connect to computing device 110 via network interface 142. Examples of networked computing devices include a server, a desktop computer, a mobile computing device, such as a smartphone or tablet computer, and/or a worn device, such as a wristwatch or headphones or a head-mounted display device. In some embodiments, the networked computing devices may be used as audio sensor(s) 172, input device(s) 174, and/or output device(s) 176.

Network 150 includes a plurality of network communications systems, such as routers and switches, configured to facilitate data communication between computing device 110 and external data store 152. Persons skilled in the art will recognize that many technically-feasible techniques exist for building network 150, including technologies practiced in deploying an Internet communications network. For example, network 150 may include a wide-area network (WAN), a local-area network (LAN), and/or a wireless (Wi-Fi) network, among others.

External data store(s) 152 include various libraries that act as a source of truth for various factual statements. For example, external data stores 152 may include backends for search engines, online encyclopedias, fact-checking websites, news websites, and so forth. In various embodiments, fact processing application 130 may search multiple external data stores 152. In such instances, fact processing application 130 may apply distinct weight values based on historical data indicating the reliability of a given external data store 152.

Sensor(s) 172 include one or more devices that collect data associated with objects in an environment. In various embodiments, sensor(s) 172 may include groups of sensors that acquire different sensor data. For example, sensor(s) 172 could include a reference sensor, such as a microphone and/or a visual sensor (e.g., camera, thermal imager, linear position sensor, etc.), which could acquire auditory data, visual data, physiological data, and so forth.

In various embodiments, sensor(s) 172 and/or input device(s) 174 may include audio sensors, such as a microphone and/or a microphone array that acquires sound data. In various embodiments, the microphone may be directional (e.g., forward-facing microphone, beamforming microphone array, etc.) and acquire auditory data from a specific person, such as speaker 160. Such sound data may be processed by fact processing application 130 using various audio processing techniques. The audio sensors may be a plurality of microphones or other transducers or sensors capable of converting sound waves into an electrical signal. The audio sensors may include an array of sensors that includes sensors of a single type, or a variety of different sensors. Sensor(s) 172 may be worn by a user, disposed separately at a fixed location, or movable. Sensor(s) 172 may be disposed in any feasible manner in the environment. In various embodiments, sensor(s) 172 are generally oriented outward relative to output device(s) 176, which are generally disposed inward of sensor(s) 172 and also oriented inward.

Sensor(s) 172 may include one or more devices that perform measurements and/or acquire data related to certain subjects in an environment. In various embodiments, sensor(s) 172 may generate sensor data that is related to speaker 160. For example, sensor(s) 172 could collect biometric data related to speaker 160 (e.g., visible perspiration, breathing rate, pupil size, eye saccades, temporary change in skin color, etc.) and/or user 180 when speaking (e.g., heart rate, brain activity, skin conductance, blood oxygenation, galvanic skin response, blood-pressure level, average blood glucose concentration, etc.). Further, sensor(s) 172 could include a forward-facing camera that records the face of speaker 160 as image data. Fact processing application 130 could then analyze the image data in order to determine the facial expression of speaker 160.

In another example, sensor(s) 172 could include sensors that acquire biological and/or physiological signals of user 180 when speaking (e.g., perspiration, heart rate, heart-rate variability (HRV), blood flow, blood-oxygen levels, breathing rate, galvanic skin response (GSR), sounds created by a user, behaviors of a user, etc.). Additionally, sensor(s) 172 could include a pupil sensor (e.g., a camera focused on the eyes of speaker 160) that acquires image data about at least one pupil of speaker 160. Fact processing application 130 could then perform various pupillometry techniques to detect eye parameters (e.g., fluctuations in the pupil diameter, direction of the pupil is gazing, eye lid position, eye saccades, etc.) as physiological data.

Input device(s) 174 are devices capable of receiving one or more inputs. In various embodiments, input device(s) 174 may include one or more audio input devices, such as a microphone, a set of microphones, and/or a microphone array. Additionally or alternatively, input device(s) 174 may include other devices capable of receiving input, such as a keyboard, a mouse, a touch-sensitive screen, and/or other input devices for providing input data to computing device 110. For example, input from the user may include gestures, such as various movements or orientations of the hands, arms, eyes, or other parts of the body that are received via a camera. In some embodiments, user 180 may trigger fact processing application 130 to perform a fact check via an input in lieu of fact processing application automatically processing each speech portion 162 made by speaker 160.

Output device(s) 176 include devices capable of providing output, such as a display screen, loudspeakers, haptic output devices, and the like. For example, output device 176 could be headphones, ear buds, a speaker system (e.g., one or more loudspeakers, amplifier, etc.), or any other device that generates an acoustic field. In another example, output device 176 could include output devices, such as ultrasound transducers, air vortex generators, air bladders, and/or any type of device configured to generate a haptic output, a proprioceptive output, a temperature output, and/or the like. In various embodiments, various input device(s) 174 and/or output device(s) 176 may be incorporated into computing device 110, or may be external to computing device 110.

In various embodiments, output device(s) 176 may be implemented using any number of different conventional form factors, such as discrete loudspeaker devices, around-the-ear (circumaural), on-ear (supraaural), or in-ear headphones, hearing aids, wired or wireless headsets, body-worn (head, shoulder, arm, etc.) listening devices, body-worn close-range directional speakers or speaker arrays, body-worn ultrasonic speaker arrays, and so forth. In some embodiments, output device(s) 176 may be worn by user 180, or disposed separately at a fixed location, or movable. As discussed above, output device(s) 176 may be disposed inward of the sensor(s) 172 and oriented inward toward a particular region or user 180.

### Techniques for Whispering Assessment of Factual Statements

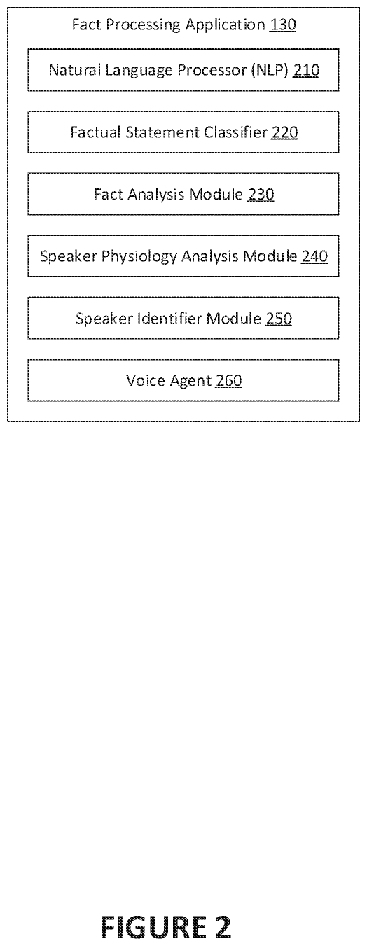

FIG. 2 illustrates components of fact processing application 130 included in the veracity assessment system 100 of FIG. 1, according to one or more embodiments. As shown, fact processing application 130 includes natural language processor 210, factual statement classifier 220, fact analysis module 230, speaker physiology analysis module 240, speaker identifier module 250, and voice agent 260.

Natural language processor 210 performs various natural language processing (NLP) techniques, sentiment analysis, and/or speech analysis in order to identify phrases spoken by speaker 160. Factual statement classifier 220 receives phrases identified by natural language processor 210 and determines a semantic meaning of a given phrase in order to determine whether the given phrase is a candidate factual statement.

Speaker physiology analysis module 240 receives speech portion 162 and/or speaker sensor data 164 from sensor(s) 172. Speaker physiology analysis module 240 processes the speech portion 162 and/or speaker sensor data 164 in order to generate a veracity value, which reflects the probability that speaker 160 is being truthful when providing speech portion 162.

In some embodiments, speaker physiology analysis module 240 may process speech portion 162 and/or speaker sensor data 164 in parallel with natural language processor 210 and factual statement classifier 220 determining whether the speech portion 162 includes a candidate factual statement. In some embodiments, speaker physiology analysis module 240 may generate a veracity value for speaker 160 making a given statement, independent of whether factual statement classifier 220 generates identifies the given statement as a candidate factual statement. In some embodiments, speaker physiology analysis module 240 and/or fact analysis module 230 may apply confidence values to the fact truthfulness value and/or the veracity value. In such instances, application of the confidence value may modify the overall likelihood that of the value and indicates the confidence that fact processing application 130 has for a given assessment.

In some embodiments, speaker physiology analysis module 240 may perform various analysis techniques on speech portion 162 to process the verbal cues of speaker 160 in order to assess the honesty of speaker 160. Such analysis could include, for example, various vocal tone heuristics, voice stress analysis (VSA), voice lie detection, voice sentiment analysis, and/or various other speech processing techniques that detect emotion and other metrics from input speech signal.

Additionally or alternatively, speaker physiology analysis module 240 may process other sensor data, such as visual data from forward-facing cameras, that is associated with speaker 160 in order to identify non-verbal cues. For example, speaker physiology analysis module 240 could perform various computer vision (CV) algorithms to classify human physiological data as indicating truthfulness, deceit, indecisiveness, and so forth. In such instances, speaker physiology analysis module 240 may identify a particular set of physiological data (e.g., a blink time of over one second, eye saccades, change in skin tone, etc.) and classify the physiological data as indicating deceit. In such instances, speaker physiology analysis module 240 may generate a low value for the veracity value.

Speaker identifier module 250 provides an identifier corresponding to speaker 160. In various embodiments, speaker identifier module 250 may maintain a speaker truthfulness database in database 126. The speaker truthfulness database may include entries that identify each speaker and stores a value (“historical veracity value”) generated by speaker physiology analysis module 240 that indicates how truthful the speaker was when making previous factual statements. In some embodiments, the historical veracity value may be a specific measurement, such as whether speaker 160 demonstrated stress above a threshold level when making one or more previous statements. Alternatively, the veracity value may be a generated metric, such as an accumulated number of times, or an accumulated percentage of times that speaker 160 made a factual statement that was true.

In various embodiments, speaker physiology analysis module 240 may subsequently analyze physiology data of speaker 160 when fact processing application 130 evaluates a subsequent candidate factual statement. When generating a historical veracity value that is associated with the subsequent candidate factual statement, speaker physiology analysis module 240 may retrieve one or more historical veracity values from database 126 that are associated with a given speaker. In such instances, speaker physiology analysis module 240 may update the stored historical veracity value. For example, database 126 may store a moving average of the probability that the last ten factual statements made by the user were true (e.g., P_{avg}=0.6). Speaker physiology analysis module 240 could update the moving average based on a new probability (e.g., P_{current}=0.4) and cause fact analysis module 230 to use the updated average (e.g., P_{avg}=0.55) when making evaluations.

Fact analysis module 230 receives the candidate factual statement that was identified by factual statement classifier 220 and generates a fact truthfulness assessment for the candidate factual statement. In various embodiments, fact analysis module 230 searches external data store(s) 152 to identify known facts, where each external data store 152 acts as a source of truth. In such instances, fact analysis module 230 compares the candidate factual statement to a corresponding known fact in order to assess whether the candidate factual statement is correct. In some embodiments, fact analysis module 230 may search multiple external data stores 152 that represent distinct sources of truth. In such instances, the fact analysis module may apply weight values to each comparison when determining whether the candidate factual statement is correct. Additionally or alternatively, user 180 may select which external data stores 152 and/or internal databases 126 that fact analysis module 230 is to search.

In some embodiments, fact analysis module 230 may generate a set of fact veracity assessments that weighs the veracity value and the fact truthfulness value. In such instances, the fact analysis module 230 may generate the set of veracity assessments that includes both the veracity value and fact truthfulness value. For example, fact analysis module 230 could compare the candidate factual statement (e.g., “I never lie about the price”) to external data stores 152 (e.g., pricing searches, competitor websites, etc.) that do not provide a distinctive conclusion on whether the statement is objectively true, generating a relatively neutral fact truthfulness value. In such instances, fact analysis module 230 could separately generate a veracity value that more strongly indicates whether the speech portion 162 made by speaker 160 is likely true (e.g., a very high or very low veracity value).

Voice agent 260 synthesizes one or more phrases that are to be generated as an auditory signal. For example, voice agent 260 could synthesize a phrase that is included in a feedback auditory signal, where the phrase indicates the specific fact veracity assessments 342 (e.g., “the speaker may be trying to lie, yet that statement was true.”) and generate an output signal to drive one or more loudspeakers included in output device 176 to emit soundwaves corresponding to synthesized phrase. Additionally or alternatively, output device 176 may be a haptic output device, and/or a device that provides haptic sensations, proprioceptive sensations, temperature sensations, and/or the like as feedback. In such instances, fact analysis module 230 and/or another module (e.g., an output controller) generates a command signal to provide feedback indicating the specific fact veracity assessment (e.g., two long pulses or raising the temperature of a device to indicate a likely untrue statement).

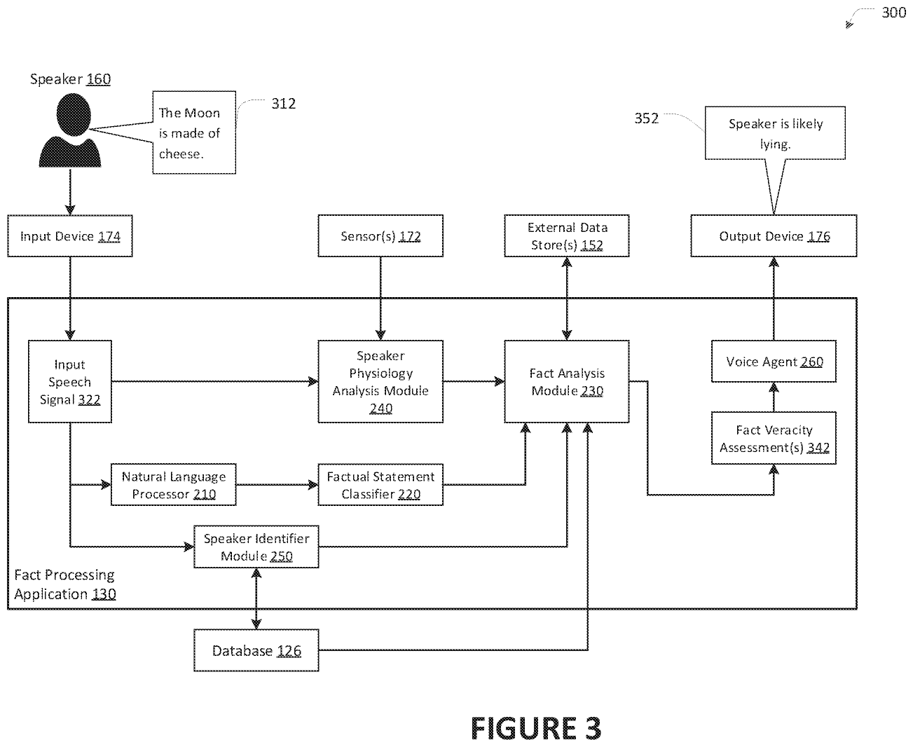

FIG. 3 illustrates a technique of the veracity assessment system 100 of FIG. 1 processing a candidate factual statement made by a speaker, according to one or more embodiments. As shown, veracity assessment system 300 includes fact processing application 130, database(s) 126, external data store(s) 152, sensor(s) 172, input device 174, and output device 176. Fact processing application 130 includes natural language processor 210, factual statement classifier 220, fact analysis module 230, speaker physiology analysis module 240, speaker identifier module 250, and voice agent 260.

In operation, input device 174 receives a speech portion 312 made by speaker 160 and transmits speech portion 312 as input speech signal 322 to fact processing application 130. In some embodiments, fact processing application 130 may also receive sensor data acquired by sensor(s) 172 that is associated with physiological data of speaker 160. Fact processing application 130 parses and analyzes speech portion 312 to identify any candidate factual statements included in input speech signal 322. Fact processing application 130 also refers to various external data store(s) 152 to determine whether the candidate factual statement is correct and generates a fact truthfulness value indicating the likelihood that the candidate factual statement is true.

In various embodiments, fact processing application 130 may also process speech portion 312 and physiological data to separately generate a veracity value indicating the likelihood that speaker 160 is attempting to provide a true statement. In various embodiments, fact analysis module 230 may generate a set of fact veracity assessments 342 that includes each of the fact truthfulness value and the veracity value. In some embodiments, fact analysis module 230 may combine the fact truthfulness value and the veracity value into a single score that comprises the fact veracity assessment. Fact processing application 130 then drives output device(s) 176 to provide an output based on the fact veracity assessments 342.

In some embodiments, fact analysis module 230 may combine portions of fact veracity assessments 342 to generate a single score. For example, fact analysis module 230 could generate a fact truthfulness value. Fact analysis module 230 could then combine the fact truthfulness value with the veracity value generated by speaker physiology analysis module 240 to generate a composite score to reflect an overall likelihood that the statement is true. In such instances, the likelihood that speaker 160 is intending to tell the truth may modify the likelihood that the statement made by speaker 160 is objectively true.

Input device 174 acquires auditory data from speaker 160. For example, input device 174 could be a forward-facing microphone included in a device worn by user 180 that acquires speech portion 312 made by speaker 160. In some embodiments, input device 174 may acquire speech portion 312 made by speaker 160 without acquiring an auditory signal made by user 180. For example, input device 174 could include directional microphone array that forms a steerable beam directed towards speaker 160. In such instances, input device 174 could acquire speech portion 312 from speaker 160 without acquiring speech from other talkers, including user 180.

Input device 174 sends the acquired auditory data to fact processing application 130 that processes the auditory data as input speech signal 322. Additionally or alternatively, sensor(s) 172 may acquire other speaker sensor data 164 associated with speaker 160. For example, sensor 172 may be a micro camera included in a wearable device that acquires visual data focused on speaker 160. The micro camera may send speaker sensor data 164 to fact processing application 130 to generate physiological data (e.g., pupil size, eye gaze direction, blink rate, eye saccades, mouth shape, etc.) from the acquired visual data.

Natural language processor 210 performs various natural language processing (NLP) techniques, sentiment analysis, and/or speech analysis in order to identify phrases spoken by speaker 160. In various embodiments, factual statement classifier 220 may receive a phrase identified by natural language processor 210 and determine a semantic meaning of a phrase in order to determine whether the specific phrase is a candidate factual statement.

In various embodiments, speaker physiology analysis module 240 receives input speech signal 322 and/or speaker sensor data 164 from sensor(s) 172. Speaker physiology analysis module 240 processes the input speech signal 322 and/or speaker sensor data 164 in order to generate a veracity value, which reflects a probability that speaker 160 is attempting to tell the truth when making speech portion 312. In some embodiments, speaker identifier module 250 may provide an identifier corresponding to speaker 160. In such instances, speaker physiology analysis module 240 may retrieve previous veracity values from database 126 that are associated with the identified speaker. Speaker physiology analysis module 240 may then generate a veracity value for the current candidate factual statement based on both processing the current input speech signal 322 and/or current speaker sensor data 164, as well as the historical veracity values.

In some embodiments, speaker physiology analysis module 240 may process input speech signal 322 and/or speaker sensor data 164 in parallel with natural language processor 210 and factual statement classifier 220 determining whether the input speech signal 322 includes a candidate factual statement. In some embodiments, speaker physiology analysis module 240 may generate a veracity value independent of whether factual statement classifier 220 identifies a given statement as a candidate factual statement.

In some embodiments, speaker physiology analysis module 240 may perform various analysis techniques on input speech signal 322 in order to assess the verbal cues of speaker 160 in order to assess the honesty of the speaker. Such analysis could include, for example, voice stress analysis (VSA), voice lie detection, voice sentiment analysis, and/or various other speech processing techniques that detect emotional states and other metrics, such as emotional arousal and/or emotional valence, from input speech signal 322.

Additionally or alternatively, speaker physiology analysis module 240 may process other sensor data, such as visual data from forward-facing cameras, that is associated with speaker 160 in order to identify non-verbal cues. For example, speaker physiology analysis module 240 could perform various computer vision (CV) algorithms to classify human physiological data as indicating truthfulness, deceit, indecisiveness, and so forth. In such instances, speaker physiology analysis module 240 may identify a particular set of physiological data (e.g., a blink time of over one second, eye gaze direction and direction changes, rapid blink rate, eye saccades, etc.) and classify the physiological data as indicating deceit. In such instances, speaker physiology analysis module 240 may generate a low value for the veracity value.

Fact analysis module 230 receives the candidate factual statement that was identified by factual statement classifier 220 and generates a fact truthfulness value and/or a set of fact veracity assessments 342 associated with the candidate factual statement. In various embodiments, fact analysis module 230 searches external data store(s) 152 to identify known facts, where each external data store 152 acts as a source of truth. In such instances, fact analysis module 230 compares the candidate factual statement to a corresponding known fact from the external data store(s) 152 in order to assess whether the candidate factual statement is correct and generate the fact truthfulness value. In some embodiments, fact analysis module 230 may search multiple external data stores 152 that represent distinct sources of truth. In such instances, the fact analysis module may apply different weights to each separate fact truthfulness value in order to generate a composite fact truthfulness value.

Upon generating fact veracity assessments 342, fact analysis module 230 outputs fact veracity assessments 342 to another module and/or output device 176 in order to produce one or more responses corresponding to fact veracity assessments 342. For example, fact analysis module 230 may transmit fact veracity assessments 342 to voice agent 260. Voice agent 260 could retrieve audio clips and/or synthesize phrases that indicate the specific fact veracity assessments 342 (e.g., “she is trying to tell you a lie.”) and generate an output signal to drive one or more loudspeakers included in output device 176 to emit soundwaves 352 based on the output signal. In some embodiments, voice agent 260 may wait until speaker 160 is no longer speaking before driving the output signal. For example, voice agent 260 could first determine that speaker 160 is no longer speaking before sending an output signal to output device 176.

Additionally or alternatively, output device 176 may be a haptic output device. In such instances, fact analysis module 230 and/or another module (e.g., a haptic output controller) generates a command signal to provide haptic feedback indicating the specific fact veracity assessments 342 (e.g., two long pulses to indicate a likely untrue statement).

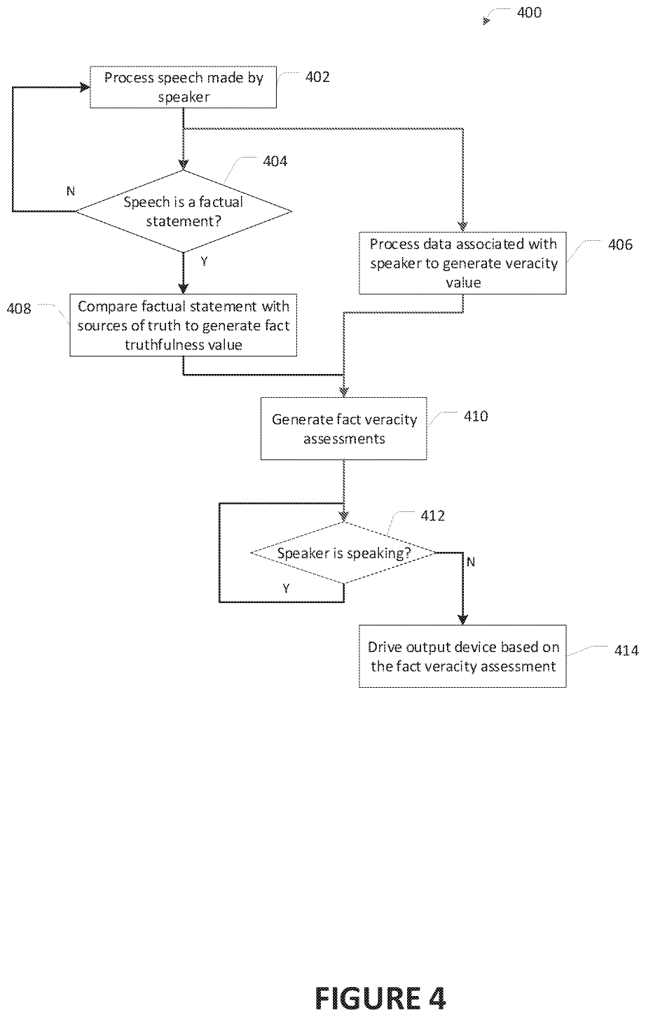

FIG. 4 is a flow diagram of method steps to apply processing a candidate factual statement made by a speaker, according to one or more embodiments. Although the method steps are described with respect to the systems of FIGS. 1-3, persons skilled in the art will understand that any system configured to perform the method steps, in any order, falls within the scope of the various embodiments. In some embodiments, veracity assessment system 100 may continually execute method 400 on captured audio in real-time.

Method 400 begins at step 402, where fact processing application 130 processes speech made by a speaker. In various embodiments, natural language processor 210 included in fact processing application 130 receives an input speech signal 322 corresponding to a speech portion 312 made by a speaker 160. Natural language processor 210 identifies a speech portion included in the input speech signal 322.

At step 404, fact processing application 130 determines whether the speech is a factual statement. In various embodiments, factual statement classifier 220 included in fact processing application 130 processes the speech portion of input speech signal 322 in order to determine whether the speech portion is a candidate factual statement. When factual statement classifier 220 determines that the speech portion is a candidate factual statement, fact processing application 130 proceeds to step 408. Otherwise, factual statement classifier 220 determines that the speech portion is not a candidate factual statement and fact processing application 130 returns to step 402 to process subsequent speech portions made by speaker 160.

At step 406, fact processing application 130 processes data associated with the speaker to generate a veracity value. In various embodiments, speaker physiology analysis module 240 included in fact processing application 130 processes input speech signal 322 as well as other physiological data in order to assess the potential honesty of the speaker. Based on various assessments of verbal and non-verbal cues made by speaker 160 when making speech portion 312, speaker physiology analysis module 240 generates a veracity value indicating a likelihood that speaker 160 is attempting to tell the truth. In some embodiments, fact processing application 130 may perform steps 404 and 406 in parallel. In such instances, speaker physiology analysis module 240 may generate a veracity value independent of factual statement classifier determining whether speech portion 312 is a candidate factual statement.

At step 408, fact processing application 130 compares the candidate factual statement with one or more sources of truth to generate a fact truthfulness value. In various embodiments, fact analysis module 230 included in fact processing application 130 searches one or more external data stores 152 in order to identify known facts stored in the one or more external data stores 152. In such instances, fact analysis module 230 may compare the candidate factual statement to the known facts in order to assess whether the candidate factual statement is correct and generate the fact truthfulness value. In some embodiments, fact analysis module 230 may search multiple external data stores 152 that correspond to different sources of truth. In such instances, fact analysis module 230 may apply distinct weights (e.g., applying heavier weights to more reliable external data stores 152) to each comparison. Additionally or alternatively, fact processing application 130 could refer to internal data stores, such as a calendar stored in database 126.

At step 410, fact processing application 130 generates fact veracity assessments. In various embodiments, fact analysis module 230 may generate a set of fact veracity assessments 342 that includes each of the fact truthfulness value and the veracity value. In some embodiments, fact analysis module 230 may combine the fact truthfulness value and the veracity value into a single score that comprises the fact veracity assessment.

At step 412, fact processing application 130 may optionally determine whether the speaker 160 is speaking. In various embodiments, fact processing application 130 may wait to provide the set of fact veracity assessments 342 until speaker 160 stops speaking. In such instances, fact processing application 130 may acquire auditory data from input device(s) 174 and/or sensor(s) 172. Voice agent 260 may then use the acquired data to determine whether speaker 160 is currently speaking. Upon determining that speaker 160 is currently speaking, fact processing application 130 returns to step 412. Otherwise, fact processing application 130 proceeds to step 414.

At step 414, fact processing application 130 drives an output device based on the fact veracity assessment(s) 342. In various embodiments, fact processing application 130 may generate a feedback signal that indicates the value of fact veracity assessments 342. For example, voice agent 260 included in fact processing application 130 could synthesize a phrase indicating the specific value for fact veracity assessments 342. Some examples include a slightly probable lie that generates the phrase, “that statement might be a lie,” a probable truth generates the phrase, “he's very likely trying to tell the truth”, a definite lie generates the phrase, “what she just said is definitely untrue,” and so forth. In such instances, voice agent 260 could generate a feedback signal corresponding to an auditory signal including the synthesized phrase and drive a loudspeaker included in output device 176 to emit soundwaves corresponding to the feedback signal.

In sum, a fact processing application receives an input speech signal corresponding to speech made by a speaker that is talking to a user. A natural language processor included in the fact processing application identifies a speech portion included in the input speech signal, and a factual statement classifier processes the speech portion to identify a candidate factual statement. A fact analysis module generates a fact truthfulness value that is associated with the candidate factual statement. In various embodiments, the fact analysis module included in the fact processing application searches one or more data stores to identify known facts stored in the one or more data stores. The fact analysis module compares the candidate factual statement to the known facts in order to generate the fact truthfulness value that indicates a likelihood that the candidate factual statement is true. In some embodiments, the fact analysis module may search multiple sources of truth. In such instances, the fact analysis module may apply weights to each comparison when generating the fact truthfulness value.

In various embodiments, a speaker physiology analysis module included in the fact processing application also processes the input speech signal, as well as other physiological data, in order to evaluate tonal and non-tonal cues of the speaker. The speaker physiology analysis module uses the evaluation to generate a veracity value that indicates a likelihood that the speaker is attempting to tell the truth. In some embodiments, a speaker identifier module identifies the speaker and associates the identified speaker to the speech portion and veracity value. In such instances, the speaker physiology analysis module may retrieve previous veracity values from storage when generating the veracity value for the current candidate factual statement.

The fact analysis module outputs the fact truthfulness value and the veracity value in a feedback signal that drives an output device. For example, a voice agent included in the fact processing application could synthesize a phrase indicating the fact truthfulness value and the veracity value included in the feedback signal, and drive a loudspeaker to emit soundwaves corresponding to the feedback signal. In various embodiments, the fact processing application continually processes successive statements made by the speaker. In such instances, the fact processing application updates the veracity value based on the physiological data associated with each of the successive statements made by the speaker.

At least one technological advantage of the disclosed approach relative to the prior art is that by processing and assessing factual statements made by a speaker, as well as cues made by the speaker in real-time, the disclosed approach provides the user with relevant feedback about factual statements and the intent of the speaker without requiring the user to take affirmative steps, interrupt conversations, and/or follow-up on statements at a later time. Further, providing assessments regarding the factual veracity of statements made by a speaker enables a user to better assess facts presented to the user based on both a statement made by a speaker, as well as other cues associated with the speaker. These technical advantages provide one or more technological advancements over prior art approaches.

1. In various embodiments, a computer-implemented method comprising detecting a speech portion included in a first auditory signal generated by a speaker, determining that the speech portion comprises a factual statement, comparing the factual statement with a first fact included in a first data source, determining, based on comparing the factual statement with the first fact, a fact truthfulness value, and providing a response signal that indicates the fact truthfulness value.

2. The computer-implemented method of clause 1, further comprising acquiring sensor data associated with the speaker, processing the sensor data to generate physiological data associated with the speaker, and generating, based on the physiological data, a veracity value indicating a likelihood that the speaker is attempting to make a truthful statement.

3. The computer-implemented method of clause 1 or 2, further comprising associating the speaker with a speaker identifier, associating at least one of the fact truthfulness value or the veracity value with the speaker identifier, and updating a speaker database based on the speaker identifier and at least one of the fact truthfulness value or the veracity value.

4. The computer-implemented method of any of clauses 1-3, where generating the veracity value comprises applying vocal tone heuristics or voice stress analysis to the speech portion.

5. The computer-implemented method of any of clauses 1-4, further comprising combining the fact truthfulness value with the veracity value to generate a fact veracity assessment, wherein the response signal indicates the fact veracity assessment.

6. The computer-implemented method of any of clauses 1-5, where the sensor data comprises biometric data including at least one of pupil size, eye gaze direction, blink rate, mouth shape, visible perspiration, breathing rate, pupil size, eye lid position, eye saccades, or temporary change in skin color.

7. The computer-implemented method of any of clauses 1-6, where the response signal comprises a signal that drives a loudspeaker to emit a second auditory signal.

8. The computer-implemented method of any of clauses 1-7, further comprising determining whether the speaker is speaking, wherein the response signal is provided upon determining that the speaker is not speaking.

9. The computer-implemented method of any of clauses 1-8, where the response signal comprises a command signal that drives an output device to generate at least one of a haptic output, a proprioceptive output, or a thermal output.

10. The computer-implemented method of any of clauses 1-9, further comprising comparing the factual statement with a second fact included in a second data source, applying a first weight to a first comparison of the factual statement with the first fact to generate a first weighted value, and applying a second weight to a second comparison of the factual statement with the second fact to generate a second weighted value, wherein determining the fact truthfulness value is based on both the first weighted value and the second weighted value.

11. In various embodiments, a system that indicates an assessment of a statement made by a user, where the system comprises at least one microphone that acquires an auditory signal of a speaker, and a computing device that detects a speech portion included in a first auditory signal generated by the speaker, determines that the speech portion comprises a factual statement, compares the factual statement with a first fact included in a first data source, determines, based on comparing the factual statement with the first fact, a fact truthfulness value, and provides a response signal that indicates the fact truthfulness value.

12. The system of clause 11, further comprising a set of one or more sensors that acquire sensor data associated with the speaker, wherein the computing device further processes the sensor data to generate physiological data associated with the speaker, and generates, based on the physiological data, a veracity value indicating a likelihood that the speaker is attempting to make a truthful statement.

13. The system of clause 11 or 12, where the set of one or more sensors includes one or more front-facing visual sensors, and the sensor data comprises biometric data including at least one of pupil size, eye gaze direction, blink rate, mouth shape, visible perspiration, breathing rate, pupil size, eye lid position, eye saccades, or temporary change in skin color.

14. The system of any of clauses 11-13, further comprising a haptic output device that generates a haptic output, wherein the response signal comprises a command signal that drives the haptic output device to generate the haptic output.

15. The system of any of clauses 11-14, where the at least one microphone comprises a forward-facing microphone that acquires the first auditory signal without acquiring an auditory signal generated by the user.

16. The system of any of clauses 11-15, where the at least one microphone generates a steerable beam that acquires the first auditory signal.

17. In various embodiments, one or more non-transitory computer-readable media storing instructions that, when executed by one or more processors, cause the one or more processors to perform the steps of detecting a speech portion included in a first auditory signal generated by a speaker, determining that the speech portion comprises a factual statement, comparing the factual statement with a first fact included in a first data source, determining, based on comparing the factual statement with the first fact, a fact truthfulness value, and providing a response signal that indicates the fact truthfulness value.

18. The one or more non-transitory computer-readable media of clause 17, further storing instructions that, when executed by the one or more processors, cause the one or more processors to perform the steps of acquiring sensor data associated with the speaker, processing the sensor data to generate physiological data associated with the speaker, and generating, based on the physiological data, a veracity value indicating a likelihood that the speaker is attempting to make a truthful statement.

19. The one or more non-transitory computer-readable media of clause 17 or 18, where the physiological data is generated while determining that the speech portion comprises the factual statement.

20. The one or more non-transitory computer-readable media of any of clauses 17-19, further storing instructions that, when executed by the one or more processors, cause the one or more processors to perform the step of generating a set of fact veracity assessments that includes the fact truthfulness value and the veracity value, wherein the response signal indicates each value included in the set of fact veracity assessments.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method comprising:
detecting a speech portion included in a first auditory signal generated by a speaker;
determining that the speech portion comprises a factual statement;
comparing the factual statement with a first fact included in a first data source;
determining, based on comparing the factual statement with the first fact, a fact truthfulness value; and
providing a response signal that indicates the fact truthfulness value.

2. The computer-implemented method of claim 1, further comprising:
acquiring sensor data associated with the speaker;
processing the sensor data to generate physiological data associated with the speaker; and
generating, based on the physiological data, a veracity value indicating a likelihood that the speaker is attempting to make a truthful statement.

3. The computer-implemented method of claim 2, further comprising:
associating the speaker with a speaker identifier;
associating at least one of the fact truthfulness value or the veracity value with the speaker identifier; and
updating a speaker database based on the speaker identifier and at least one of the fact truthfulness value or the veracity value.

4. The computer-implemented method of claim 2, wherein generating the veracity value comprises applying vocal tone heuristics or voice stress analysis to the speech portion.

5. The computer-implemented method of claim 2, further comprising combining the fact truthfulness value with the veracity value to generate a fact veracity assessment, wherein the response signal indicates the fact veracity assessment.

6. The computer-implemented method of claim 2, wherein the sensor data comprises biometric data including at least one of pupil size, eye gaze direction, blink rate, mouth shape, visible perspiration, breathing rate, pupil size, eye lid position, eye saccades, or temporary change in skin color.

7. The computer-implemented method of claim 1, wherein the response signal comprises a signal that drives a loudspeaker to emit a second auditory signal.

8. The computer-implemented method of claim 7, further comprising determining whether the speaker is speaking, wherein the response signal is provided upon determining that the speaker is not speaking.

9. The computer-implemented method of claim 1, wherein the response signal comprises a command signal that drives an output device to generate at least one of a haptic output, a proprioceptive output, or a thermal output.

10. The computer-implemented method of claim 1, further comprising:
comparing the factual statement with a second fact included in a second data source;
applying a first weight to a first comparison of the factual statement with the first fact to generate a first weighted value; and
applying a second weight to a second comparison of the factual statement with the second fact to generate a second weighted value,
wherein determining the fact truthfulness value is based on both the first weighted value and the second weighted value.

11. A system that indicates an assessment of a statement made by a user, the system comprising:
at least one microphone that acquires an auditory signal of a speaker; and
a computing device that:
detects a speech portion included in a first auditory signal generated by the speaker;
determines that the speech portion comprises a factual statement;
compares the factual statement with a first fact included in a first data source;
determines, based on comparing the factual statement with the first fact, a fact truthfulness value; and
provides a response signal that indicates the fact truthfulness value.

12. The system of claim 11, further comprising a set of one or more sensors that acquire sensor data associated with the speaker, wherein the computing device further:
processes the sensor data to generate physiological data associated with the speaker; and
generates, based on the physiological data, a veracity value indicating a likelihood that the speaker is attempting to make a truthful statement.

13. The system of claim 12, wherein:
the set of one or more sensors includes one or more front-facing visual sensors; and
the sensor data comprises biometric data including at least one of pupil size, eye gaze direction, blink rate, mouth shape, visible perspiration, breathing rate, pupil size, eye lid position, eye saccades, or temporary change in skin color.

14. The system of claim 11, further comprising a haptic output device that generates a haptic output, wherein the response signal comprises a command signal that drives the haptic output device to generate the haptic output.

15. The system of claim 11, wherein the at least one microphone comprises a forward-facing microphone that acquires the first auditory signal without acquiring an auditory signal generated by the user.

16. The system of claim 11, wherein the at least one microphone generates a steerable beam that acquires the first auditory signal.

17. One or more non-transitory computer-readable media storing instructions that, when executed by one or more processors, cause the one or more processors to perform the steps of:
detecting a speech portion included in a first auditory signal generated by a speaker;
determining that the speech portion comprises a factual statement;
comparing the factual statement with a first fact included in a first data source;
determining, based on comparing the factual statement with the first fact, a fact truthfulness value; and
providing a response signal that indicates the fact truthfulness value.

18. The one or more non-transitory computer-readable media of claim 17, further storing instructions that, when executed by the one or more processors, cause the one or more processors to perform the steps of:
acquiring sensor data associated with the speaker;
processing the sensor data to generate physiological data associated with the speaker; and
generating, based on the physiological data, a veracity value indicating a likelihood that the speaker is attempting to make a truthful statement.

19. The one or more non-transitory computer-readable media of claim 18, wherein the physiological data is generated while determining that the speech portion comprises the factual statement.

20. The one or more non-transitory computer-readable media of claim 18, further storing instructions that, when executed by the one or more processors, cause the one or more processors to perform the step of:
generating a set of fact veracity assessments that includes the fact truthfulness value and the veracity value,
wherein the response signal indicates each value included in the set of fact veracity assessments.
